(19) United States
(12) Patent Application Publication
(10) Pub. No.: US 2005/0155196 A1
(43) Pub. Date: Jul. 21, 2005

(54) Casket with themed cap insert

(76) Inventors: Paul Holzman, Mason, OH (US); Jamie D. Riddle, Sunman, IN (US)

Correspondence Address: WOOD, HERRON, & EVANS, LLP, 2700 CAREW TOWER, 441 VINE STREET, CINCINNATI, OH, 45202, US

(21) Appl. No.: 10/759,612

(22) Filed: Jan. 16, 2004

(51) Int. Cl. A61G 17/00

(52) U.S. Cl. 27/14

(57) ABSTRACT

A casket of the type which allows it to be personalized to the deceased comprises a shell, a cap closable upon the shell and a cap insert removably secured onto an upper side of the cap and including themed designs that are personalized to the deceased. The casket cap may include an embossed or recessed area to receive the personalized cap insert. The cap insert is secured to the casket cap by flexing the insert to create a frictional fit between the edges of the cap insert and the embossed area. The casket may further include a mounting adaptor having a base secured to the embossed area and at least one vertical spacer to which a generally planar cap insert is removably secured. The cap insert may have various sayings, symbols, or other themed designs formed therein with special meaning to the deceased thus providing a more personalized funeral experience.

### FIELD OF THE INVENTION

This invention relates generally to the death care industry, and more particularly to personalization of casket caps or lids for memorializing a deceased.

### BACKGROUND OF THE INVENTION

Upon the death of a family member the surviving loved one of the deceased must make a number of decisions, including what type of funeral or other memorial service to hold, preparation of the body, selection of a suitable casket or cremation urn, etc. In the death care industry it is conventional for those decisions to be made in a so-called “arrangement conference.” In an arrangement conference, the funeral director meets with the surviving loved one of the deceased, typically in the funeral home of the funeral director, and describes to and discusses with the surviving loved one the various funeral products and services which are available. The funeral director may use visual aids such as a product catalog, product display board (such as that disclosed in the assignee's U.S. Pat. No. 5,787,626 titled Funeral Product Display Case hereby incorporated by reference herein) and a casket selection room (such as that disclosed in the assignee's U.S. Pat. No. 5,405,017 titled Modular Casket Display System and in the assignee's pending application Ser. No. 09/638,576 titled Display For A Casket Selection and/or Viewing Room both hereby incorporated by reference herein) to illustrate the products available to the customer.

There is a trend in the death care industry to make efforts towards “personalizing” the funeral products and the funeral or other memorial service purchased for the deceased to provide a more meaningful memorial experience for the family and friends of the deceased. One of the earlier attempts at providing a means of personalizing or customizing a casket to the deceased may be seen with reference to the assignee's U.S. Pat. No. 4,457,054 titled Casket Shelf, hereby incorporated by reference herein. That patent discloses a casket shelf which is mounted to the dish assembly of the head end cap when the head end cap is in the open position. The shelf provides a surface for supporting and displaying articles of religious or personal significance to the deceased.

Many casket manufacturers and funeral directors now manufacture and offer many “custom modular” variations of caskets, rather than selling mere “cookie cutter” or “one size fits all” caskets, thereby allowing the loved one to in essence design a specific casket especially suited or tailored to the deceased. For example, customers can select from a number of casket materials, casket finishes, casket corner adornments and casket interiors. Advances made in the area of “quick change” and “tool less” fastening mechanisms have greatly facilitated the rapid removal of one accessory from the casket and the rapid installation of another more desirable accessory to the casket. In addition to promoting personalization of the casket to the deceased, such interchangeability greatly reduces the amount of inventory the funeral director must keep on hand. An example may be seen in the assignee's U.S. Pat. No. 6,591,466 titled Quick Change Casket Corner Attachment Mechanism and hereby incorporated by reference herein, commercially available as the LifeSymbols® line of interchangeable corner adornments available from Batesville®.

The “custom” casket interiors available to the funeral customer today include not only the internal lining material of the casket (which itself may also be of the quick-change type, see the Assignee's U.S. Pat. No. 5,784,768 titled Casket Having Quickly Interchangeable And Adjustable Interior and hereby incorporated by reference herein) but also the decorative cap panels that fit within the underneath of the casket cap which serve to present a visually aesthetically pleasing appearance to the underside of the cap when in the open position. The cap panel can be embroidered with a favorite saying of the deceased, a scene depicting the deceased's hobby, etc. Special cap panels have even been designed which, in addition to performing a memorial function while installed in the casket, are adapted to be presented to the loved one surviving the deceased to be displayed by the loved one in his or her home as a keepsake. See application U.S. Pat. No. 6,237,202 titled Dish Assembly For A Casket Cap assigned to the assignee of the present invention and hereby incorporated by reference herein, the subject of which is commercially available as the MemoryFrame™ line of cap panels available from Batesville®. The casket can also include a memorabilia drawer in which keepsakes of the deceased can be stored and displayed, as disclosed in the assignee's U.S. Pat. No. 5,611,124 titled Casket Having Memorabilia Compartment and hereby incorporated by reference herein, commercially available as the MemorySafe® line of caskets including memorabilia drawers available from Batesville®.

Advances have therefore been made in the area of “personalization” of funeral products as demonstrated with the novel products discussed above. However, there continues to be room for improvement in the area of personalization in the death care industry.

### SUMMARY OF THE INVENTION

The present invention is a cap insert for a casket of the type which allows it to be personalized to the deceased. The casket comprises a shell, a cap, or lid, closable upon the shell and a cap insert removably secured in an upper side of the cap, the cap insert including themed designs that are personalized to the deceased.

The casket cap generally includes a head end cap and a foot end cap. The head end cap is usually in an opened position for viewing of the deceased during the funeral ceremony, and the foot end cap is usually in a closed position and traditionally acts as a place holder for floral arrangements and the like. In the present invention, the cap insert is removably secured onto the upper side of the closed foot end cap and is personalized to the deceased to provide a more meaningful funeral service. The cap insert may comprise a rectangular panel having a pair of opposed shorter sides and a pair of opposed longer sides and may generally be conformed to the shape of the casket cap.

The casket of this invention may further comprise an embossed, or recessed, area within the casket cap to receive the personalized cap insert. The cap insert is positioned into the embossed area and secured to the casket by a frictional fit between the edges of the cap insert and the edges of the embossed area. Alternatively, a mounting adaptor may be secured to the embossed area and a generally planar cap panel secured to the adaptor.

The cap insert may be made of metal, leather, marble or other suitable materials capable of being engraved or having various designs formed therein. The cap insert may be engraved with various sayings or have embossed designs formed in the cap insert having a particular theme with a personalized meaning to the deceased.

Methods are also provided for constructing the above casket.

These and other features and advantages of the present invention will become more readily apparent during the following detailed description taken in conjunction with the drawings herein, in which:

### BRIEF DESCRIPTION OF THE DRAWINGS OF THE INVENTION

FIG. 1 is a perspective view of a casket including a foot end cap with a cap insert having a personalized design according to the principles of the present invention;

FIG. 2 is a perspective view of the foot end cap and cap insert of FIG. 1 showing an embossed area and the cap insert removably positioned into the embossed area;

FIG. 3 is a view taken along line 3-3 of FIG. 2;

FIG. 4 is a view similar to that of FIG. 3 showing a mounting adaptor for mounting a generally planar cap insert to the foot end cap.

FIG. 5 is a perspective view of a casket where the cap insert comprises an embossed design; and.

FIG. 6 is a perspective view of a casket where the cap insert comprises a leather design.

### DETAILED DESCRIPTION OF A PREFERRED EMBODIMENT OF THE INVENTION

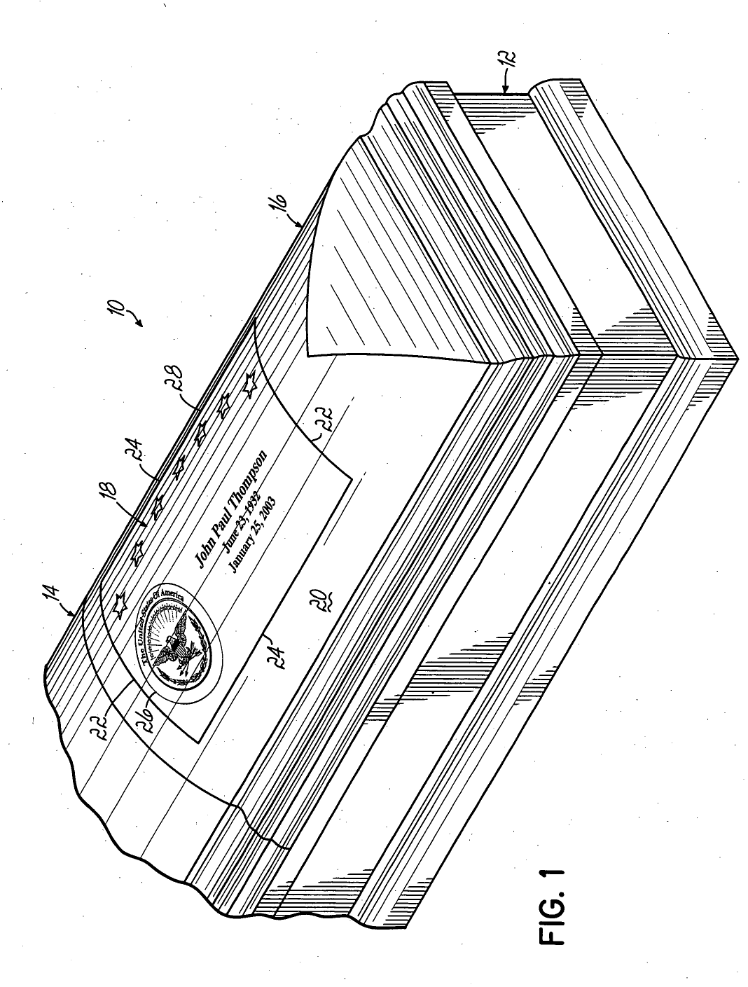

With reference to FIG. 1, there is illustrated a portion of a casket 10 according to the present invention. The casket 10 includes a lower body containing portion or shell 12, a head end cap 14 pivoted to a rear upper edge of the shell 12 and a foot end cap 16 likewise pivoted to the rear upper edge of the shell 12.

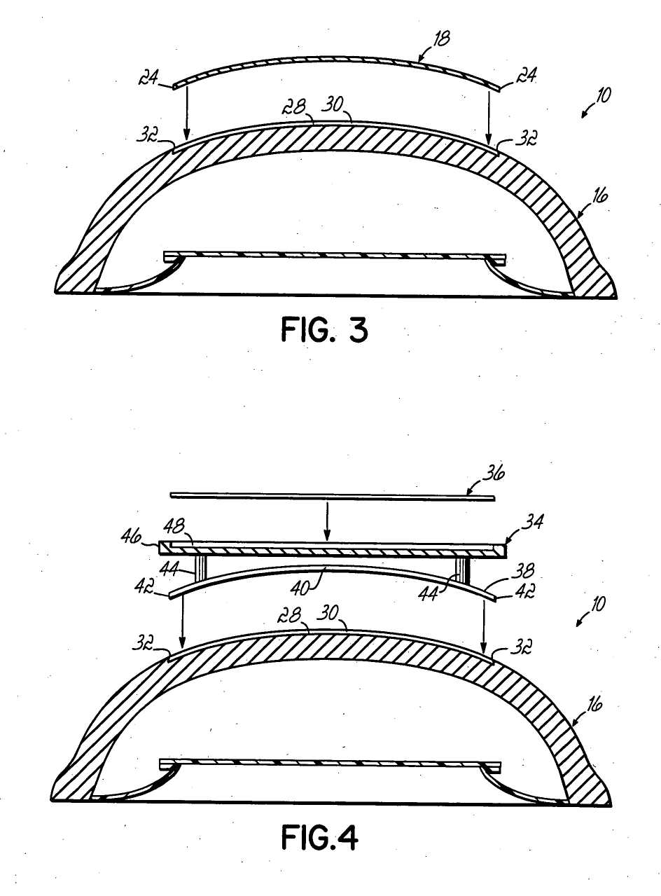

Referring now to FIGS. 1-3, the foot end cap 16 may include a cap insert 18 removably secured to an upper (i.e., exterior, upwardly-facing) side 20 of foot end cap 16. By way of example, the foot end cap 16 can have a generally rectangular cap insert 18 having a pair of opposed shorter sides 22, 22 and a pair of opposed longer sides 24, 24. The cap insert 18 may include a themed design 26 personalized to the deceased, such as for example, the deceased's name, year deceased was born, year deceased died, and the seal of the United States to signify service to his/her country. It is to be understood that a virtually limitless number of designs may be formed in the cap inserts to personalize the casket to the deceased.

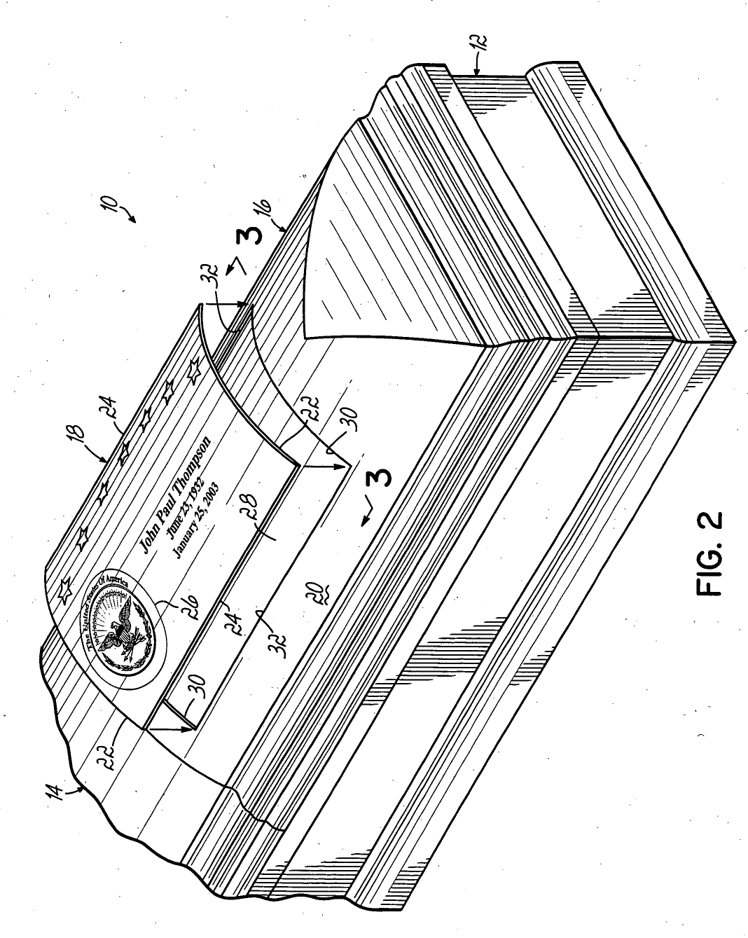

The foot end cap 16 may include an embossed, or recessed, area 28 adapted to removably receive cap insert 18. If casket 10 is fabricated of sheet metal, recessed area 28 could be formed by stamping. If casket 10 is fabricated of wood, recessed area 28 could be formed by routing. If casket 10 is a cremation casket or so-called “alternative container” fabricated of combustible material such as card board, fiber board or oriented strand board, embossed area 28 could be formed by these or other methods known to those skilled in the art of fabrication with such materials. The embossed area 28 generally conforms to the shape of the cap insert 18. Thus, as shown in FIG. 2, recessed area 28 is rectangular having a pair of opposed shorter sides 30, 30 and a pair of opposed longer sides 32, 32 that correspond to the shorter sides 22, 22 and longer sides 24, 24, respectively, of the cap insert 18. The cap insert 18 may be positioned into the embossed area 28 and secured to foot end cap 16 by, for example, flexing cap insert 18 so that corresponding sides 22, 22/30, 30 and 24, 24/32, 32 of the cap insert 18 and the embossed area 28 frictionally fit together. Additionally, the cap insert 18 may be removably secured to the foot end cap 16 by other means known in the art, such as adhesives, double-sided tape or hook and loop type fasteners.

Referring now to FIG. 4, the casket 10 may further include a mounting adaptor 34 for securing a cap insert 36 to the foot end cap 18. The mounting adaptor comprises a rectangular base 38 having a pair of opposed shorter sides 40, 40 and a pair of opposed longer sides 42, 42 that correspond to opposed shorter sides 30, 30 and opposed longer sides 32, 32, respectively, of the embossed area 28 in foot end cap 16. The base 38 is positioned into embossed area 28 and removably secured to the foot end cap 16 by, for example, flexing base 38 so that corresponding sides 40, 40/30, 30 and 42, 42/32, 32 of the base 38 and embossed area 28, respectively, frictionally fit together. The mounting base 38 may be removably secured to the foot end cap 16 by other means known in the art, such as adhesives, double-sided tape or hook and loop type fasteners. Mounting adaptor 34 further comprises one or more vertical spacers 44 for mounting the cap insert 36 to the mounting adaptor 34. Spacers 44 may take any form that provides a vertical space between the foot end cap 16 and the cap insert 36, such as horizontally-extending spacer bars extending along opposed sides 40, 40, 42, 42 of the base 38 or vertically-oriented bars, posts or tubes at the corners of base 38. Cap insert 36 may be coupled directly to vertical spacers 44, or the mounting adaptor 34 may further include a housing 46 secured to vertical spacers 44 and having a recess 48 formed therein for receiving cap insert 36. Cap insert 36 may be removably secured to housing 46 by frictionally fitting cap insert 36 into recess 48, or by other known means. Mounting adaptor 34 thus permits generally planar cap insert 36 to be removably secured to foot end cap 16. This is advantageous when cap insert 36 is inflexible or unable to conform to the curvature of the foot end cap 16, or otherwise when it is desired for cap insert 36 to be displayed in a planar configuration.

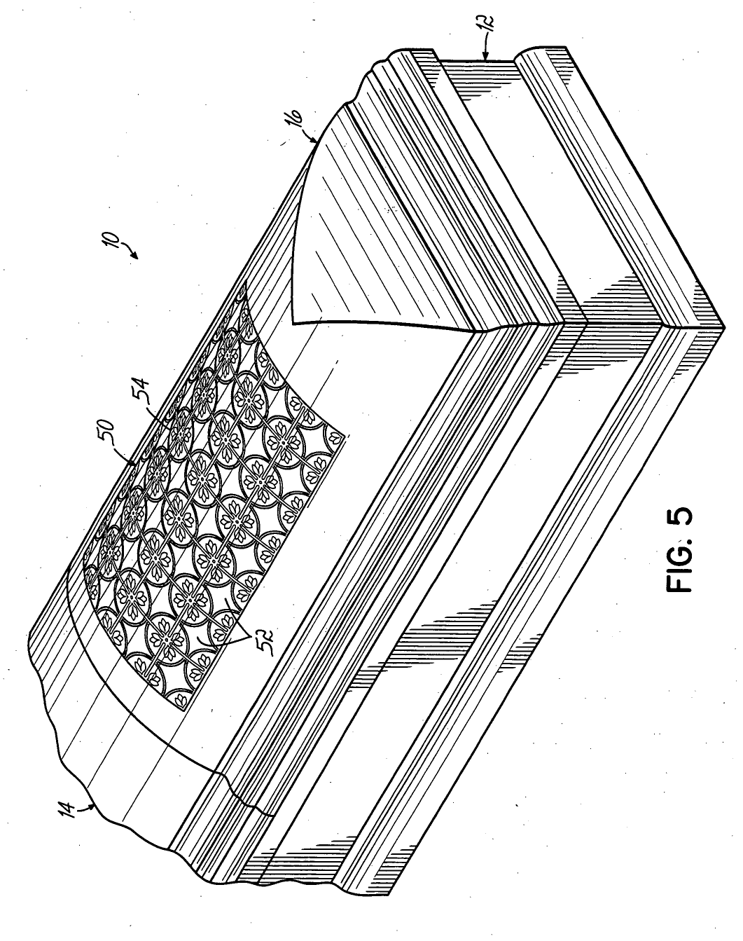

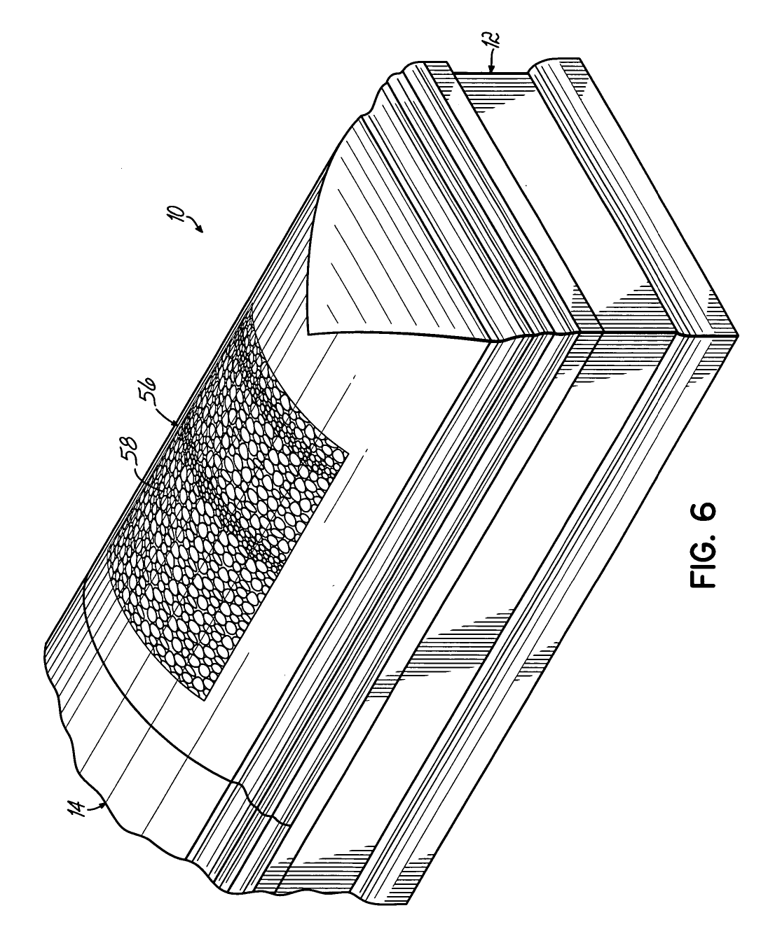

Cap inserts according to the present invention may be formed from a wide range of materials, such as metal, leather, marble, acrylic or other suitable materials known in the art capable of being engraved (FIG. 1), embroidered, or otherwise capable of having a favorite saying formed therein or having various designs formed therein. For example, FIG. 5 shows a cap insert 50 made from one or more metal or plastic panels 52 having an embossed design 54 formed therein. The design may be chosen as having particular significance to the deceased. Moreover, FIG. 6 shows a cap insert 56 made from leather and having a design 58 formed in the leather. Through the use of different materials and/or sayings or designs, cap inserts may be personalized to the deceased.

Those skilled in the art will readily recognize numerous adaptations and modifications which can be made to the present invention which will result in an improved casket, yet all of which will fall within the spirit and scope of the present invention as defined in the following claims. Accordingly, the invention is to be limited only by the scope of the following claims and their equivalents.

1. A casket comprising:
a casket shell;
a casket cap closeable upon said shell; and
a cap insert removably secured in an upper side of said cap.

2. The casket of claim 1 further comprising an emboss formed in an upper surface of said cap, said cap insert removably secured in said emboss.

3. The casket of claim 2 wherein said cap insert is frictionally fit into said emboss on said cap.

4. The casket of claim 2 further comprising:
a mounting adaptor secured to said emboss on said cap;
said cap insert removably secured to said adaptor.

5. The casket of claim 4 wherein said mounting adaptor comprises:
a base, said base secured to said emboss on said cap;
at least one vertical spacer, said at least one spacer having one end portion coupled to said base and other end portion adapted to removably secure said cap insert.

6. The casket of claim 5 further comprising:
a housing coupled to said at least one vertical spacer, said housing having a recess formed therein for receiving said cap insert.

7. The casket of claim 5 wherein said cap insert is generally planar.

8. The casket of claim 5 wherein said base is frictionally fit into said emboss on said cap.

9. The casket of claim 1 wherein said cap-comprises:
a head end cap; and
a foot end cap, said cap insert positioned onto said foot end cap.

10. The casket of claim 1 wherein said cap insert is rectangular with a pair of opposed shorter sides and a pair of opposed longer sides.

11. The casket of claim 1 wherein said cap has a shape, said cap insert conforming to said shape of said cap.

12. The casket of claim 11 wherein said cap is arcuate and said cap insert is matingly arcuate.

13. The casket of claim 1 wherein said cap insert is metal.

14. The casket of claim 1 wherein said cap insert is leather.

15. The casket of claim 1 wherein said cap insert is marble.

16. A method of constructing a casket comprising:
providing a casket shell;
providing a casket lid;
forming an emboss in an upper surface of the lid;
providing a decorative lid insert; and
installing the lid insert in the lid emboss.

17. The method of claim 16 wherein the casket is fabricated of metal and the emboss is formed by stamping.

18. The method of claim 16 wherein the casket is fabricated of wood and the emboss is formed by routing.

19. The method of claim 16 wherein the lid insert is fabricated of metal.

20. The method of claim 16 wherein the lid insert is formed of leather.

21. The method of claim 16 wherein the cap insert is formed of marble.

22. The method of claim 16 further comprising:
providing the casket lid with a curved upper surface; and
providing the lid insert with a mating curvature.

23. The method of claim 16 further comprising:
providing the casket lid with a curved upper surface;
providing a lid insert mounting adaptor configured to fit into the emboss of the curved upper surface of the lid and configured to receive and display the lid insert in a planar configuration;
installing the mounting adaptor in the lid emboss; and
attaching the lid insert to the mounting adaptor.
